(19) United States
(12) Patent Application Publication
(10) Pub. No.: US 2026/0303329 A1
(43) Pub. Date: Oct. 1, 2026

(54) SECURITY PROTECTION FOR RADIO ACCESS NETWORK (RAN)

(71) Applicant: T-Mobile Innovations LLC, Overland Park, KS (US)

(72) Inventors: John HUMBERT, Roeland Park, KS (US); Jun LIU, Sammamish, WA (US); Jean TRAKINAT, Valrico, FL (US); Mark YOUNGE, Golden, CO (US)

(21) Appl. No.: 19/097,682

(22) Filed: Apr. 1, 2025

(51) Int. Cl. H04L 9/08; H04L 9/40; H04W 74/0833

(52) U.S. Cl. CPC H04L 9/085; H04L 63/0807; H04W 74/0833

(57) ABSTRACT

A method performed by a user equipment (UE) in a wireless communication system, the method including receiving, from a base station (BS), system information associated with a cell; and performing an authentication procedure with the BS, wherein the performing the authentication procedure includes receiving, from the BS, a challenge message comprising first shared secret information; transmitting, to the BS, a challenge response message comprising second shared secret information; and receiving, from the BS, an approval message; and initiating a cell camping procedure based on the approval message.

### CROSS-REFERENCE TO RELATED APPLICATIONS

None.

### STATEMENT REGARDING FEDERALLY SPONSORED

### Research or Development

Not applicable.

### Reference to a Microfiche Appendix

Not applicable.

### BACKGROUND

In a wireless communication system, a user equipment (UE) may begin searching for a network (e.g., when the UE first powers on) by scanning frequencies in one or more supported frequency bands to discover cells that are using those frequencies. To facilitate cell discovery, a base station (BS) serving a cell may broadcast various signals and information associated with the cell on one or more frequencies. When the UE discovers a cell meeting certain cell selection criteria, the UE can consider the cell to be a suitable cell. The UE can also select a cell and camp on the selected cell.

### SUMMARY

In an embodiment, a method performed by a user equipment (UE) in a wireless communication system is provided. The method includes receiving, from a base station (BS), system information associated with a cell; and performing an authentication procedure with the BS, wherein the performing the authentication procedure includes receiving, from the BS, a challenge message comprising first shared secret information or a first variable; transmitting, to the BS, a challenge response message comprising second shared secret information; and receiving, from the BS, an approval message; and initiating a cell camping procedure based on the approval message.

In another embodiment, a method performed by a base station (BS) serving a cell in a wireless communication system is provided. The method includes transmitting system information associated with the cell; and performing an authentication procedure with a user equipment (UE), wherein the performing the authentication procedure comprises transmitting, to the UE, a challenge message comprising first pre-shared secret information; receiving, from the UE, a challenge response message comprising second pre-shared secret information; and transmitting, to the UE, an approval message; receiving, from the UE, an initiation of a camping procedure based on the approval message.

In yet another embodiment, a method performed by a user equipment (UE) in a wireless communication system is provided. The method includes acquiring, from a base station (BS) associated with a cell, a master information block (MIB) comprising a secure token associated with the BS; comparing the secure token associated with the BS to a secure token associated with the UE; and continuing to acquire system information associated with the cell based on a match between the secure token associated with the BS and the secure token associated with the UE.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIGS. 1A and 1B are diagrams of a wireless communication system according to an embodiment of the disclosure.

FIG. 2 is a sequence diagram illustrating an example method of providing secure token-based security protection in a radio access network (RAN) according to an embodiment of the disclosure.

FIG. 3 is a sequence diagram illustrating an example method of providing user equipment (UE)-base station (BS) mutual authentication-based security protection in a RAN according to an embodiment of the disclosure.

FIG. 4 is a sequence diagram illustrating an example method of performing a mutual authentication procedure between a UE and a BS as part of a random access procedure according to an embodiment of the disclosure.

FIG. 5 is a flow chart of a method according to an embodiment of the disclosure.

FIG. 6 is a flow chart of another method according to an embodiment of the disclosure.

FIG. 7 is a flow chart of yet another method according to an embodiment of the disclosure.

FIG. 8 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As used herein, a home operator of a user equipment (UE) may refer to the mobile network provider to which the UE has a subscription. A public land mobile network (PLMN) operated by the home operator may be referred to as a home public land mobile network (HPLMN), a home operator network, or a home network. The HPLMN may hold the subscription of the UE and is responsible for authentication, billing, and management. A roaming operator may refer to a different mobile network provider that provides services to the UE when the UE is roaming (outside of the UE’s home network coverage). For instance, the roaming operator may be a roaming partner of the home operator. A PLMN operated by the roaming operator may be referred to as a visited public land mobile network (VPLMN), a roaming operator network, or a roaming partner network.

In the context of third generation partnership project (3GPP) fifth-generation (5G) or sixth-generation (6G), a base station (BS) serving a cell in a radio access network (RAN may transmit synchronization signal blocks (SSBs) to enable UEs to detect, synchronize, and establish a connection (e.g., radio resource control (RRC) connection) to the BS. The BS may also be referred to as a next generation node B (gNB) or an access node (AN). The SSBs may include a primary synchronization signal (PSS), a secondary synchronization (SSS), a physical broadcast channel (PBCH) carrying a master information block (MIB), and a demodulation reference signal (DMRS) to facilitate PBCH decoding. The MIB may indicate whether the cell is barred and where (e.g., in frequency and/or time) a system information block (SIB) type 1 (SIB 1) that may be transmitted by the BS among various other information.

After a UE powers up, the UE is in an idle mode (e.g., RRC idle mode) and may establish a connection with the network to perform data transfer and/or to make and/or receive voice calls. This is done using an initial access via an RRC connection establishment procedure. To establish a connection to the BS, the UE may perform PLMN (or standalone non-public network (SNPN)) selection and cell selection (or reselection). To that end, the UE may acquire and decode a MIB from the BS. If the MIB indicates the cell is barred, the UE may acquire a different cell. If the cell is not barred, the UE may acquire minimum system information (e.g., a system information block (SIB), such as SIB type 1 (SIB 1)) based on the resource information (e.g., time and/or frequency resource information) indicated by the MIB. The UE may find out from SIB 1 which PLMN the cell belongs and cell selection criteria, such as minimum required reference signal received power (RSRP) thresholds (e.g., RxLevmin thresholds).

To facilitate PLMN or SNPN selection, the UE may be configured with a list of PLMNs and associated radio access technologies (RATs) in a priority order (e.g., by the home operator of the UE). The PLMNs may include an HPLMN (e.g., operated by the home operator) and one or more VPLMNs (e.g., operated by a roaming partner of the home operator). The UE may also be configured with a list of equivalent home public land mobile network (EHPLMN) that may be considered as equivalent to the HPLMN and/or a list of forbidden public land mobile network (FPLMN) that the UE is not allowed to request for a connection. In some instances, the UE may further be configured with a list of SNPNs. In some instances, the PLMN identifiers (IDs) for the various list of PLMNs and/or SNPN IDs for the list of SNPNs may be stored at a subscriber identity module (SIM) card or an embedded SIM (eSIM) of the UE.

The UE may perform a PLMN selection (or an SNPN selection) based on a comparison of the PLMN ID acquired from the cell (e.g., the PLMN that the cell belongs to) to the various PLMN lists configured at the UE. For instance, if the PLMN ID matches one of the HPLMN ID, VPLMN ID(s), EHPLMN ID(s), or SNPN ID(s), the UE may determine that that PLMN as a candidate PLMN. If, however, the PLMN ID matches an FHPLMN ID or does not match any of the HPLMN ID, VPLMN IDs, EHPLMN ID, or SNPN ID(s), the UE may disregard that PLMN (e.g., as a candidate PLMN). Generally, the UE may search for various cells by repeating the MIB and SIB 1 acquisition for each detected cell and collect candidate PLMN IDs. After collecting various candidate PLMN IDs, the UE may determine the most preferred network based on the list of PLMNs and associated RATs in the priority order. As an example, the list may indicate that the HPLMN ID with 5G has the highest priority, followed by the HLMN with long-term evolution (LTE), an EHPLMN ID with 5G, a previously registered PLMN ID with 5G, and so on.

After selecting a PLMN, the UE may perform RSRP measurements of different cells within the selected PLMN. The UE may compare the RSRP measurements of the different cells to select a cell with the strongest signal strength (e.g., the highest RSRP). For instance, the UE may perform the RSRP measurement comparison and cell selection based on the RxLevmin thresholds (obtained from SIB 1). After selecting the cell with the strongest signal strength, the UE may camp on the selected cell. To camp on the cell, the UE may first perform a random access procedure to establish an RRC connection with the BS of the selected cell. In some examples, after a UE selects a PLMN, a UE may camp on a cell without applying the strongest cell criteria.

Subsequently, the UE may perform a network attachment or registration procedure with a core network (CN) (e.g., a 5G core or a 6G core) coupled to the selected cell (e.g., via non-access stratum (NAS) signaling). As part of the network attachment or registration procedure, the CN and the UE may perform an authentication procedure, and the UE may camp on the cell based at least in part on the authentication with the CN being successful. While the UE is camped on a cell, the UE may perform cell reselection using substantially similar mechanisms as the cell selection. In an example, the UE may perform a cell reselection when the signal strength of the camped cell falls below certain threshold(s) and/or when the signal strength of another cell is greater than the signal strength of the camped cell by certain threshold(s). The PLMN selection, the SNPN selection, and the cell selection and/or reselection procedures are described in 3GPP documents TS 38.304 (release 18) (“TS 38.304 document”) clause 5.1 and 5.2 and TS 23.122 v19.1.0 (2024-12) (“TS 23.122 document”) clause 4.4 and 4.9, which are hereby incorporated by reference herein in their entireties.

As can be seen from the cell selection and/or reselection discussed above, cell selection and/or reselection are based on UE selection and/or reselection alone and there is no authentication until the UE communicates with the CN, where the authentication is between the UE and the CN. Thus, there is a lack of security protection in the RAN (e.g., as discussed in 3GPP document TR 33.809 v18.1.0 (2023-09), which is hereby incorporated by reference herein in its entirety). This can be problematic as a bad or malicious actor may set up a false BS mimicking operations of a legitimate BS. The UE may be unaware of the false BS being operated by a bad actor. Thus, the UE may attach to the false BS and provide the false BS with important UE information (e.g., personal identify information (PII) information). Attaching to a false BS may also enable the false BS to track the UE. In some cases, the false BS may further direct the UE to other web sites and perform more malicious actions (e.g., obtaining user credentials to other institutions, such as banking institution, etc.). Accordingly, there is a need to provide security protection in a RAN before a UE starts to attach to a CN.

The present disclosure provides a technical solution to the aforementioned technical problems in the technical field of cell selection and/or cell reselection in a wireless communication system. More specifically, security protection may be extended from a CN through a RAN to ensure connections and communications by a user device (e.g., user equipment (UE)) through the RAN is secure. For instance, a security element may be added to a UE and a BS to ensure that secure information is not exchanged until a verification of the authenticity of the BS and the mobile network operator behind the BS is successful. Stated differently, a security element is added to prevent the UE from selecting and camping on a cell operated by a non-legitimate BS (false BS).

In one embodiment, a secure token (e.g., a numeric value, an alphanumeric string, a binary value, a hexadecimal value, etc.) is stored at a BS and broadcast in a MIB, and an HPLMN provisions each UE (of the HPLMN) with the same secure token. The UE acquires and decodes a MIB and only proceeds with SIB acquisition if a secure token in the MIB matches the secure token stored at the UE. To facilitate roaming, an HPLMN provisions each UE (of the HPLMN) with another secure token (e.g., a roaming secure token) and shares the roaming secure token with roaming partner networks. Each roaming partner network may then configure BSs of the roaming partner network with the roaming secure token. That is, each UE is configured with one secure token for use in the HPLMN and/or a common roaming secure token for use in all roaming partner networks. Similarly, each BS is configured with one secure token for serving UEs of the HPLMN and/or a roaming secure token for serving roaming UEs. Thus, a BS may transmit a MIB including two secure tokens. The HPLMN can dynamically update the secure token for use in the HPLMN and/or the roaming secure token for use in roaming partner networks. Alternatively, each BS and each UE may be configured with one secure token for use in an HPLMN. When the UE roams to a VPLMN, the UE may apply a certain function to the secure token, a corresponding PLMN ID, and an additional parameter (e.g., a random number) to create a unique token and verify an authenticity of a BS in the VPLMN based on the created token.

In another embodiment, a UE-BS mutual authentication procedure between a UE and a BS is added into the cell selection and/or reselection procedure. For instance, an HLPMN provisions all UEs and all BSs (of the HPLMN) with a pre-shared secret (e.g., a numeric value, an alphanumeric string, a binary value, a hexadecimal value, etc.) that can be routinely changed (or updated). The pre-shared secret may also be referred to as a secret value, a secret parameter, a secrete message, secrete data, or secret information. The HPLMN further provisions all UEs and all BSs with a variable (e.g., a numeric value, an alphanumeric string, a binary value, a hexadecimal value, etc.) that may be updated more frequently than the pre-shared secret. The pre-shared secret and the variable are stored at each respective BS and UE. A BS and a UE may perform a mutual authentication procedure based on a combination of the pre-shared secret and the variable (e.g., a hash of the pre-shared secret and the variable). The UE may only select a cell for camping if the mutual authentication procedure is successful. To facilitate roaming, the HPLMN may provide each UE with another pre-shared secret (e.g., a roaming pre-shared secret) and another variable (e.g., a roaming variable) and provide roaming partner networks with the roaming pre-shared secret and the roaming variable. That is, each UE is configured with pre-shared secret information and a variable for use in the HPLMN and a common pre-shared secret information and a roaming variable for use in all roaming partner networks. Similarly, each BS is configured with pre-shared secret information and a variable for serving UEs of the HPLMN and roaming pre-shared secret information and a roaming variable for serving roaming UEs. These embodiments may reduce malicious traffic in the RAN, thereby protecting the connections between the UE and the BS through the RAN (before reaching the CN).

According to an embodiment of the present disclosure, a wireless communications system may include a BS serving a cell in a RAN that is connected to a CN. The BS may transmit a MIB including a secure token associated with the BS. The secure token associated with the BS may be stored at the BS. A UE may acquire and decode the MIB to extract the secure token from the MIB. The UE may verify the authenticity of the BS by comparing the value of the secure token (e.g., the secure token value) associated with the BS (extracted from the MIB) to the value of a secure token (e.g., the secure token value) associated with the UE. The secure token associated with the UE may be stored at the UE.

In an embodiment, a home operator of the UE may preconfigure the UE with two secure tokens, one for use in a home network (e.g., an HPLMN) and another one for use in a roaming network (e.g., VPLMN) while the UE is roaming. More specifically, the two secure tokens may include a first secure token that is the same as the secure token configured at BSs of the home operator and a second secure token that is the same as the secure token configured at BSs of roaming operators (e.g., as shared by the home operator). Thus, in one embodiment, the secure token associated with the UE may correspond to the first secure token associated with the home operator of the UE (e.g., for use when the UE is within the coverage of the home operator). In another embodiment, the secure token associated with the UE may correspond to the second secure token associated with the roaming operator (e.g., for use when the UE is outside the coverage of the home operator).

If the UE determines that there is a mismatch between the value of the secure token associated with the BS in the received MIB and the value of the secure token associated with the UE, the UE may acquire a different cell. That is, upon the UE determining the mismatch, the UE may not continue to acquire system information (e.g., at least SIB 1). If, however, the UE determines that there is a match between the value of the secure token associated with the BS (in the received MIB) and the value of the secure token associated with the UE, the UE may continue to acquire system information (e.g., at least SIB 1) associated with the cell and evaluate the cell for selection and/or camping as discussed above.

In some embodiments, the home operator may dynamically update (e.g., daily, weekly, monthly, etc.) a secure token for the home operator network and/or a secure token for roaming partner networks. Thus, in some instances, the UE may receive an updated secure token for an HPLMN or for a VPLMN. Subsequently, upon the UE receiving a MIB, the UE may use the updated secure token to verify the authenticity of the BS that transmitted that MIB. In some embodiments, the UE may bypass the verification of a secure token received from a MIB based on a special call (e.g., an emergency call, such as a 911 number, a 112 number, or any other country-specific emergency number) being initiated at the UE. In this way, the special call may not be gated in case the secure token verification fails.

According to another embodiment of the present disclosure, a BS and a UE may perform a mutual authentication during a cell selection and/or reselection. For instance, a UE may acquire system information, perform PLMN selection, and select a cell with the strongest signal strength (e.g., RSPR measurements) as discussed above. However, the UE may not camp on the selected cell until the UE successfully performs a mutual authentication procedure with the BS. In other words, a UE may select a strongest cell that passes a UE-BS mutual authentication within a selected PLMN for camping. In this way, the UE may only attach to a CN (which is part of a camping procedure) after the BS authenticity is verified successfully.

To perform the mutual authentication, the UE may transmit a cell pre-selection message to the BS. The cell pre-selection message may indicate an initiation of a mutual authentication procedure with the BS (e.g., a request for authentication). Upon the BS receiving the cell pre-selection message, the BS may transmit, to the UE, a challenge message (e.g., including a challenge value, which may be a numeric value, an alphanumeric string, a binary value, a hexadecimal value, etc.). For instance, the BS may generate the challenge value based on first pre-shared secret information and a first variable, in which the first pre-shared secret information may be shared between the BS and UEs that are of the same operator as the BS. In some instances, the challenge message may include a hash of the first pre-shared secret information and the first variable. Upon the UE receiving the challenge message, the UE may decode the challenge message to verify an identity of the BS (e.g., the first pre-shared secret information embedded in the challenge message). The verification may include determining whether the decoded first pre-shared secret information matches second pre-shared secret information stored at the UE, in which the second pre-shared secret information is shared between the UE and BSs associated with the home operator of the UE or associated with a roaming operator (e.g., a roaming partner of the home operator) of the UE.

If the verification of the BS identity fails (e.g., a mismatch between the decoded first pre-shared secret information and the second pre-shared secret information stored at the UE), the UE may acquire a different cell. If, however, the verification is successful (e.g., a match between the decoded first pre-shared secret information and the second pre-shared secret information stored at the UE), the UE may transmit, to the BS, a challenge response (e.g., including a response value, which may be a numeric value, an alphanumeric string, a binary value, a hexadecimal value, etc.). For instance, the UE may generate the response value based on the second pre-shared secret information and a second variable. In some instances, the challenge response message may include a hash of the second pre-shared secret information and the second variable.

Upon the BS receiving the challenge response message, the BS may decode the challenge response message to verify an identity of the UE (e.g., the second pre-shared secret information embedded in the challenge response message). The verification may include determining whether the decoded second pre-shared secret information matches the first pre-shared secret information stored at the BS. Generally, the BS and the UE may each select respective pre-shared secret information and variable from the pre-shared secret information and variable configured for HPLMN use or the roaming pre-shared secret information and variable configured for roaming based on whether the UE is in an HPLMN or not. For instance, the UE may determine whether the selected PLMN ID corresponds to the UE’s HPLMN ID. In an example, the UE may include, in the cell pre-selection message or the challenge response message, an indication whether the UE is in an HPMN or a VPLMN, and the BS may then use the corresponding pre-shared secret information and variable based on the HPLMN or VPLMN indication.

If the verification of the UE identity is successful, the BS may transmit, to the UE, an approval message to approve the UE to continue with the cell selection. The approval message may include a predetermined value indicating an approval status. Upon the UE receiving the approval message, the UE may proceed to select the cell for camping. If, however, the verification fails, the BS may not transmit the approval message to the UE. Alternatively, the BS may transmit a disapproval message indicating the verification failure. Upon the UE failing to receive the approval message (e.g., after a certain timeout period) or receiving a disapproval message, the UE may acquire a different cell. That is, the UE may select a most suitable cell for camping not only based on the cell having a highest signal strength (e.g., a highest RSRP measurement) within a selected PLMN but also based on a successful mutual authentication with the BS.

In some embodiments, a home operator may configure each BS and each UE (of the home operator network) respectively with a pair of BS public and private keys and a pair of UE public and private keys for use in a UE-BS mutual authentication procedure. The home operator may also configure each UE (of the home operator network) with a pair of roaming UE public and private keys for use in a UE-BS mutual authentication procedure during roaming and may provide roaming partner operators with a pair of roaming BS public and private keys for use in a UE-BS mutual authentication procedure. Thus, the BS and the UE may each select a respective key-pair from a pair of public and private keys for HPLMN use or from a pair of roaming public and private keys for roaming based on whether the UE is in an HPLMN or not. For instance, the UE may determine whether the selected PLMN ID corresponds to the UE’s HPLMN ID, and the BS may determine whether the UE is in a HPLMN or a VPLMN based on the UE’s indication as discussed above. The BS may encrypt the challenge message with a respective BS public key, and the UE may decrypt the received challenge message using a respective UE private key. Similarly, the UE may encrypt the challenge response message with a respective UE public key, and the BS may decrypt the received challenge response message using a respective BS private key.

In some embodiments, the UE-BS mutual authentication may be incorporated into a random access procedure. For a contention-based random access procedure including message 1 (MSG 1), message 2 (MSG 2), message 3 (MSG 3), and message 4 (MSG 4) (e.g., as defined by 3GPP documents TS 38.321 (release 18) (“TS 38.321 document”) clause 5.1, which is hereby incorporated by reference herein in its entirety), the pre-selection message may correspond to a physical random access channel (PRACH) preamble in MSG 1, the challenge message (transmitted by the BS) may be part of MSG 2, the channel response message (transmitted by the UE) may be part of MSG 3, and the approval message (transmitted by the BS) may be part of MSG 4. For a contention free random access procedure, the pre-selection message may correspond to a PRACH preamble in MSG 1 and the challenge message (transmitted by the BS) may be part of MSG 2. The exchange of the challenge response message and the approval message may be additional to the contention free random access procedure. For a 2-step random access procedure including message A (MSG A) and message B (MSG B) (e.g., as defined by 3GPP), the pre-selection message may be part of MSG A, and the challenge message may be part of MSG B. The exchange of the response to the challenge message and the approval message may be additional to the 2-step random access procedure. In other embodiments, the UE may perform a random access procedure (e.g., a contention-based random access, a contention free random access, or a 2-step random access procedure) before performing the mutual authentication.

In some embodiments, the UE and the BS may bypass the mutual authentication with the BS based on the UE initiating a special call (e.g., an emergency call, such as a 911 number, a 112 number, or any other country-specific emergency number). For instance, the UE may indicate a special status (e.g., for emergency cause) in a RRC connection request transmitted as part of MSG 3 in a random access procedure. Generally, a UE and a BS may utilize the secure token verification and/or the mutual authentication discussed above during cell selection and/or cell reselection to provide security protection in a RAN.

In some embodiments, when a secure token-based RAN security protection is used, a roaming UE may further receive an updated secure token from a welcome message upon attaching to the roaming operator network (e.g., VPLMN) or directed to a website to obtain an updated secure token. In an example, the updated secure token may correspond to the secure token used for UEs of that roaming operator. Subsequently, the UE may use the updated secure token when acquiring cells of that particular VPLMN. In some embodiments, when a UE-BS mutual authentication-based RAN security protection is used, a roaming UE may further receive an updated pre-shared secret and variable for performing UE-BS mutual authentication from a welcome message upon attaching to the roaming operator network (e.g., VPLMN) or may be directed to a website to obtain the updated pre-shared secret and variable. In an example, the updated pre-shared secret and variable may correspond respectively to the pre-shared secret and variable used for UEs of that roaming operator. Subsequently, the UE may use the updated secure token when acquiring cells of that particular VPLMN.

Providing security protection in a RAN can prevent a UE from selecting and camping on a non-legitimate BS and providing important information (e.g., UE’s PII and/or user credentials to other institutions) to bad actors. Adding a secure token in a MIB provides a guard against non-legitimate BSs at an earliest time during an initial access procedure with a minimal signaling change to the 3GPP standard. Additionally, stopping a UE from further acquiring SIBs from a non-legitimate BS can save power, processing, and/or memory resources at the UE. Adding a UE-BS mutual authentication after selecting a most suitable cell based on RSPR measurements and before camping on the cell can further protect the UE from selecting and camping on a non-legitimate BS with minimal, localized changes to 3GPP signaling. Additionally, combining a more frequently updated variable with a longer-term pre-shared secret (in a challenge message from a BS and/or in a challenge response message from a UE) can further strengthen the security of the authentication, making it more difficult for a bad actor to decode or mimic the authentication operations. Incorporating the UE-BS mutual authentication into a random access procedure can further prevent a UE from establishing an RRC connection with a non-legitimate BS with no additional handshake (for contention-based random access) or minimal additional handshakes (for contention free random access or 2-step random access). Extending the secure token-based and/or the UE-BS authentication-based RAN security to roaming partner networks can ensure a UE is also protected against malicious BSs and bad actors during roaming.

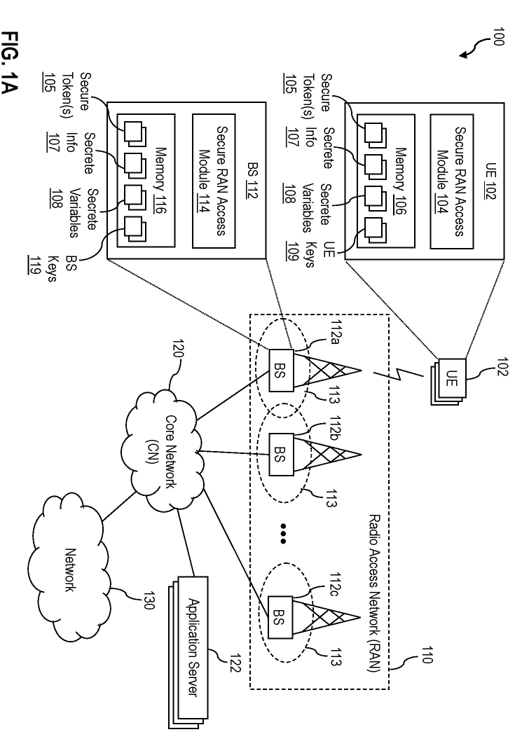

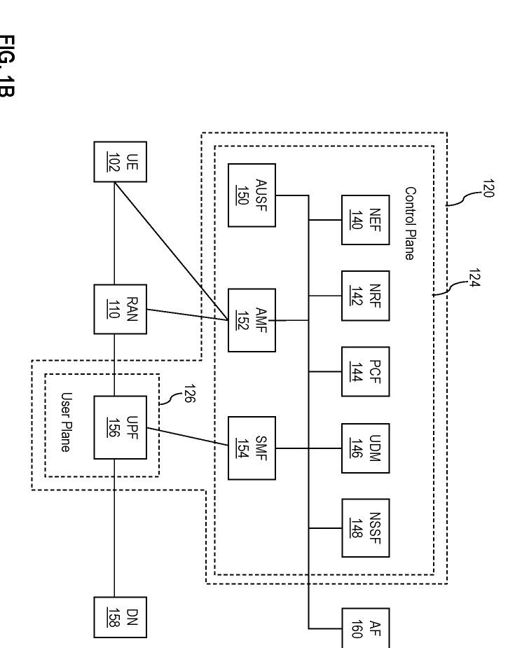

Turning now to FIG. 1A, a wireless communication system 100 that provides RAN security protection is described. The wireless communication 100 includes a number of BSs 112 that are configured to provide coverage in which UEs 102, such as cell phones, tablet computers, machine-type-communication devices, tracking devices, wearables, drones, vehicles, embedded wireless modules, and/or other wirelessly equipped communication devices (whether or not user operated), can operate. The BSs 112 may be said to establish a RAN 110. The RAN 110 may be referred to as an access network in some contexts. In 5G technology a BS 112 may be referred to as a next Generation Node B (gNB). In 4G technology (e.g., LTE technology) a BS 112 may be referred to as an evolved Node B (eNB). In 3G technology (e.g., code division multiple access (CDMA) and global system for mobile communication (GSM)) a BS 112 may be referred to as a base transceiver station (BTS) combined with a BS controller (BSC). In some contexts, the BS 112 may be referred to as a cell site or a cell tower. In some implementations, a picocell may provide some of the functionality of a BS 112, albeit with a constrained coverage area. Each of these different embodiments of a BS 112 may be considered to provide roughly similar functions in the different technology generations.

In an embodiment, the RAN 110 comprises a first BS 112a, a second BS 112b, and a third BS 112c, each providing a respective coverage or cell 113. It is understood that the RAN 110 may include any number of BSs 112. Further, each BS 112 could be coupled with a CN 120 that provides connectivity with various application servers 122 and/or a network 130. In an embodiment, at least some of the application servers 122 may be located close to the network edge (e.g., geographically close to the UE 102 and the end user) to deliver so-called “edge computing.” The network 130 may be one or more private networks, one or more public networks, or a combination thereof. The network 130 may comprise the public switched telephone network (PSTN). The network 130 may comprise the Internet. With this arrangement, a UE 102 within coverage of the RAN 110 could engage in air-interface communication with a BS 112 and could thereby communicate via the BS 112 with various application servers 122 and other entities.

The wireless communication system 100 could operate in accordance with a particular RAT, with communications from a BS 112 to UEs 102 defining a downlink or forward link and communications from the UEs 102 to the BS 112 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G” – such as LTE, which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive IoT. 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general Internet service providers for laptops and desktop computers, competing with existing ISPs such as cable Internet, and also will make possible new applications in IoT and machine to machine areas.

In accordance with the RAT, each BS 112 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in RF spectrum) having a bandwidth and a center frequency and thus extending from a low-end frequency to a high-end frequency. Further, on the downlink and uplink channels, the coverage of each BS 112 could define an air interface configured in a specific manner to define physical resources for carrying information wirelessly between the BS 112 and UEs 102.

Without limitation, for instance, the air interface could be divided over time into frames, subframes, slots, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the BS 112 could allocate as needed to carry data between the BS 112 and served UEs 102.

In addition, certain resource elements on the example air interface could be reserved for special purposes. For instance, on the downlink, certain resource elements could be reserved to carry synchronization signals that UEs 102 could be detected as an indication of the presence of coverage and to establish frame timing, other resource elements could be reserved to carry a reference signal that UEs 102 could measure in order to determine coverage strength, and still other resource elements could be reserved to carry other control signaling such as PRB-scheduling directives and acknowledgement messaging from the BS 112 to served UEs 102. And on the uplink, certain resource elements could be reserved to carry random access signaling from UEs 102 to the BS 112, and other resource elements could be reserved to carry other control signaling such as PRB-scheduling requests and acknowledgement signaling from UEs 102 to the BS 112.

The BS 112, in some instances, may be split functionally into a radio unit (RU), a distributed unit (DU), and a central unit (CU) where each of the RU, DU, and CU have distinctive roles to play in the RAN 110. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

For ease of illustration, FIG. 1A only shows one UE 102 with an expanded view and one BS 112 with an expanded view. Generally, each of the UEs 102 may have similar RAN security related components and each of the BSs 112 may have similar RAN security related components. For instance, according to embodiments of the present disclosure, a UE 102 may include a secure RAN access module 104, which may include a combination of hardware, firmware, and software components, configured to perform secure cell selection and/or reselection in the RAN 110. Further, the UE 102 may include memory 106 configured to store various information (e.g., including secure tokens 105, secret information 107, variables 108, and/or UE keys(s) 109) associated with the secure cell selection and/or reselection. In some instances, the memory 106 may be a tamper-proof module (e.g., a SIM card or an eSIM). As will be discussed more fully below, the UE 102 may or may not store all of the secure tokens 105, secret information 107, variables 108, and/or UE keys(s) 109 depending on the embodiments. A BS 112 may include a secure RAN access module 114, which may include a combination of hardware, firmware, and software components, configured to facilitate a UE 102 in performing secure cell selection and/or reselection in the RAN 110. Further, the BS 112 may include memory 116 configured to store various information (e.g., including secure tokens 105, secret information 107, variables 108, and/or BS keys(s) 119) associated with the secure cell selection and/or reselection. In some instances, the memory 116 may be a tamper-proof module. As will be discussed more fully below, the BS 112 may or may not store all of the secure tokens 105, secret information 107, variables 108, and/or BS keys(s) 119 depending on the embodiments. The secure RAN access module 104 at the UE 102 and the secure RAN access module 114 at the BS 112 may coordinate with each other to ensure connections and communications by the UE 102 with the BS 112 through the RAN 110 is secure. At a high level, a security element is added to the cell selection and/or reselection procedures to prevent a UE 102 from selecting and camping on a cell 113 operated by a non-legitimate BS 112.

In one embodiment, a secure token 105 (a numeric value, an alphanumeric string, a binary value, a hexadecimal value, etc.) is stored at a BS 112 and broadcast in a MIB, and an HPLMN may provision each UE 102 (of the HPLMN) with the same secure token 105. The UE 102 may acquire and decode a MIB and only proceed with SIB acquisition if a secure token 105 in the MIB matches the secure token 105 stored at the UE 102. To facilitate roaming, an HPLMN may provide each UE 102 (of the HPLMN) with another secure token 105 for roaming (e.g., referred to as a roaming secure token 105) and share the roaming secure token 105 with roaming partner networks (e.g., VPLMNs). That is, each UE 102 is configured with one secure token 105 for use in the HPLMN and a common roaming secure token 105 for use in all roaming partner networks. Similarly, each BS 112 is configured with one secure token 105 for serving UEs 102 of the HPLMN and a roaming secure token 105 for serving roaming UEs 102. Generally, the HPLMN or the home operator may generate the various secure tokens 105 using any suitable algorithms (e.g., a random number generation, a hash-based algorithm, Javascript object notation (JSON) web tokens (JWT), etc.).

In another embodiment, a UE-BS mutual authentication procedure is added into the cell selection procedure. For instance, an HLPMN provisions all UEs 102 and all BSs 112 (of the HPLMN) with pre-shared secret information 107 (e.g., a numeric value, an alphanumeric string, a binary value, a hexadecimal value, etc.) that can be routinely changed (or updated). The HPLMN further provisions all UEs 102 and all BSs 112 with a variable 108 (e.g., a numeric value, an alphanumeric string, a binary value, a hexadecimal value, etc.) that may be updated more frequently than the pre-shared secret information 107. The pre-shared secret information 107 and the variable 108 are stored at each respective BS 112 and UE 102. A BS 112 and a UE 102 may perform a mutual authentication procedure based on the pre-shared secret information 107 and the variable 108. In some embodiments, the UE-BS mutual authentication procedure may be based on a hash (e.g., a predetermined hash algorithm) of the pre-shared secret information 107 and the variable 108. Generally, the hash can be based on any suitable hash algorithms (e.g., message digest 5 (MD5), secure hash algorithm (SHA)-256, SHA-512, SHA-3, Blake 2 hash algorithms, etc.). The UE 102 may select a cell 113 for camping if the mutual authentication procedure is successful. To facilitate roaming, the HPLMN may provide each UE 102 with another pre-shared secret information 107 (e.g., referred to as roaming pre-shared secret information 107) and another variable (e.g., referred to as a roaming variable 108) and provide roaming partner networks with the roaming pre-shared secret information 107 and the roaming variable 108. That is, each UE 102 is configured with pre-shared secret information 107 and a variable 108 for use in the HPLMN and/or a common pre-shared secret information 107 and a roaming variable 108 for use in all roaming partner networks. Similarly, each BS 112 is configured with pre-shared secret information 107 and a variable 108 for serving UEs 102 of the HPLMN and/or roaming pre-shared secret information 107 and a roaming variable 108 for serving roaming UEs 102. Generally, the HPLMN or the home operator may generate the various pre-shared secret information 107 and/or variables 108 using any suitable algorithms (e.g., advanced encryption standard (AES), data encryption standard (DES), sub-network of an over-segmented watershed (SNOW), Zu Chongzhi (ZUC), etc.) to generate cryptographically secure data.

In some instances, an HPLMN may configure each BS 112 and each UE 102 (of the HPLMN) respectively with a pair of BS public and private keys 119 and a pair of UE public and private keys 109 for use in a UE-BS mutual authentication procedure. The HPLMN may also configure each UE 102 (of the HPLMN) with another pair of UE public and private keys 109 (e.g., referred to as roaming UE public and private keys 109) for use in a UE-BS mutual authentication procedure during roaming and may provide roaming partner networks with a pair of roaming BS public and private keys 119 for use in a UE-BS mutual authentication procedure. That is, each UE 102 is configured with a pair of UE public and private keys 109 for use in the HPLMN and/or a pair of roaming UE public and private keys 109 for use in all roaming partner networks. Similarly, each BS 112 is configured with a pair of BS public and private keys 119 for serving UEs 102 of the HPLMN and/or a pair of roaming BS public and private keys 109 for serving roaming UEs 102. Generally, the HPLMN or home operator may generate the various keys 109 and 119 using any suitable algorithms (e.g., public key infrastructure (PKI)-based, Rivest-Shamir-Adleman (RSA)-based, elliptic curve cryptography (ECC)-based, etc. In certain examples, a PKI framework with certificate management as defined in 3GPP document TS, 33.310 (release 19), which is hereby incorporated by reference herein in its entirety, may be used.

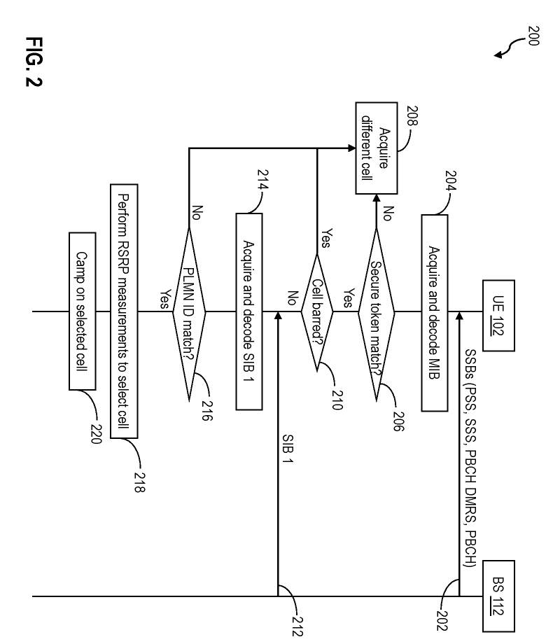

Further, in some embodiments, an HPLMN may update secure tokens 105, pre-shared secrets (e.g., the pre-shared secret information 107), and/or various public-private (or encryption-decryption) keys 109 and 119 (e.g., daily, weekly, monthly, etc.). In some instances, the HPLMN may update pre-shared secret information 107 less frequently than the corresponding variable 108 as discussed above. Generally, the secure token 105 and/or the UE-BS mutual authentication may be used to provide security protection in the RAN 110. Mechanisms for providing secure protection in the RAN 110 are discussed more fully below with reference to FIGS. 2-7. These secure token-based and/or UE-BS mutual authentication-based embodiments may reduce malicious traffic in the RAN 110, thereby protecting the connections between the UEs 102 and the BSs 112 through the RAN 110 (before reaching the CN 120).

Turning now to FIG. 1B, further details of the CN 120 are described. In an embodiment, the CN 120 is a 5G CN. 5G CN technology is based on a service-based architecture paradigm or a reference point-based architecture paradigm. Rather than constructing the 5G CN as a series of special purpose communication nodes (e.g., a home subscriber server (HSS) node, a mobility management entity (MME) node, etc.) running on dedicated server computers, the 5G CN is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 156, an authentication server function (AUSF) 150, an access and mobility management function (AMF) 152, a session management function (SMF) 154, a network exposure function (NEF) 140, a network repository function (NRF) 142, a policy control function (PCF) 144, a unified data management (UDM) 146, a network slice selection function (NSSF) 148, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G CN 120 may be segregated into a user plane 126 and a control plane 124, thereby promoting independent scalability, evolution, and flexible deployment.

The UPF 156 delivers packet processing and links the UE 102, via the RAN 110, to a data network (DN) 158 (e.g., the network 130 illustrated in FIG. 1A). The AMF 152 handles registration and connection management of NAS signaling with the UE 102. Said in other words, the AMF 152 manages UE registration and mobility issues. The AMF 152 manages reachability of the UEs 102 as well as various security issues. The SMF 154 handles session management issues. Specifically, the SMF 154 creates, updates, and removes (destroys) protocol data unit (PDU) sessions and manages the session context within the UPF 156. The SMF 154 decouples other control plane functions from user plane functions by performing dynamic host configuration protocol (DHCP) functions and IP address management functions. The AUSF 150 facilitates security processes (e.g., authentication and authorization procedures) between the CN 120 and UEs 102.

The NEF 140 securely exposes the services and capabilities provided by network functions. The NRF 142 supports service registration by network functions and discovery of network functions by other network functions. The PCF 144 supports policy control decisions and flow based charging control. The UDM 146 manages network user data and can be paired with a user data repository (UDR) that stores user data such as customer profile information, customer authentication number, and encryption keys for the information. An application function 160, which may be located outside of the CN 120, exposes the application layer for interacting with the CN 120. In an embodiment, the application function 160 may be executed on an application server 122 located geographically proximate to the UE 102 in an “edge computing” deployment mode. The CN 120 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 148 can help the AMF 152 to select the network slice instance (NSI) for use with the UE 102.

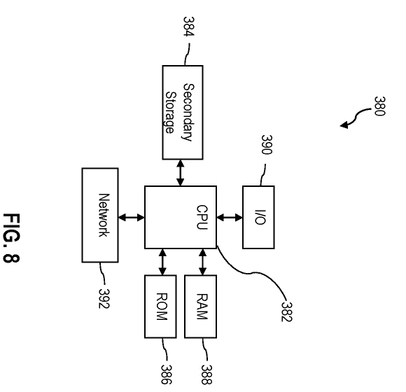

Turning now to FIG. 2, a method 200 of providing secure token-based security protection in a RAN 110 is described. The method 200 illustrates operations performed by various components of the wireless communication system 100. Specifically, the components include a UE 102 and a BS 112. In an embodiment, the operations of the UE 102 in method 200 may be implemented by a secure RAN access module 104 at the UE 102, and the operations of the BS 112 in the method 200 may be implemented by a secure RAN access module 114 at the BS 112. In some embodiments, each of UE 102 and the BS 112 may implement the operations of the method 200 using a computer system with components as shown in FIG. 8. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order.

In the method 200, an HPLMN (or a home operator) configures BSs 112 and UEs 102 of the HPLMN with the same secure token 105, and the BSs 112 broadcast MIBs including the secure token 105. To facilitate roaming, the HPLMN configures UEs 102 of the HPLMN with another secure token 105 (a roaming secure token 105) for use when the UEs 102 are outside the coverage of the HPLMN (e.g., during roaming). The HPLMN shares the roaming secure token 105 with roaming partner networks so that the roaming partner networks (e.g., VPLMNs) may also provide security protection to roaming UEs 102. Thus, each roaming partner network configures BSs 112 of the roaming partner network with the roaming secure token 105.

At operation 202, a BS 112 (serving a cell 113 in a RAN 110) may transmit SSBs, each including a PSS, an SSS, a PBCH DMRS, and a PBCH. The SSBs may be transmitted in broadcast mode and the transmission may be repeated according to a certain periodicity. The PSS may enable slot and subframe synchronization and may indicate a physical layer cell identity (PCI). The SSS may enable radio frame synchronization and may indicate a physical cell layer cell identity from a group of 335 PCI groups. The combined PCI and physical cell layer cell identity may identify the cell 113. The PBCH DMRS may be a reference signal for decoding PBCH. The PBCH may carry a MIB including basic system information and an indication of where (e.g., in frequency and time) remaining broadcast system information (e.g., SIB 1) may be transmitted. To provide security protection in the RAN 110, the MIB may further include a secure token 105 associated with the BS 112. The secure token 105 associated with the BS 112 may be configured by an operator of the BS 112. At operation 212, after the BS 112 transmitted the MIB, the BS 112 may transmit (e.g., broadcast) SIB 1 as scheduled by the MIB (e.g., using time and frequency resources as indicated by the MIB).

At operation 204, a UE 102 attempting to access the RAN 110 may acquire and decode the MIB. For instance, the UE 102 may perform an initial cell search by detecting a PSS from the BS 112. The UE 102 may achieve slot and subframe synchronization based on the PSS and identify the PCI associated with the cell 113. The UE 102 may then receive an SSS. The UE 102 may achieve frame synchronization and identify the physical cell layer cell identity associated with the cell 113. The UE 102 may decode the MIB based on the PBCH DMRS. After decoding, the UE 102 may read the MIB and extract the secure token 105 from the MIB.

As discussed above, to provide security protection in the RAN 110, the home operator of the UE 102 may configure the UE 102 with the same secure token 105 as BSs 112 of the home operator. The UE 102 may store the secure token 105 at memory (e.g., in a SIM or eSIM) of the UE 102. Thus, at operation 206, the UE 102 may compare the value of the secure token 105 associated with the BS 112 (in the MIB received at operation 204) to the value of the secure token 105 stored at the UE 102 to verify the authenticity of the BS 112. If there is a mismatch between the value of secure token 105 associated with the BS 112 and the value of the secure token 105 stored at the UE 102, the UE 102 may proceed to operation 208. At operation 208, the UE 102 may acquire a different cell 113 based on the mismatch. That is, the UE 102 may not acquire SIBs from the BS 112 and may switch to monitor for SSBs from another BS 112.

If, however, there is a match between the value of the secure token 105 associated with the BS 112 and the value of the secure token 105 stored at the UE 102, the UE 102 may proceed to operation 210. At operation 210, the UE 102 may further obtain a cell barred indicator from the MIB and determine whether the cell 113 is barred from access. If the cell barred indicator indicates that cell 113 is not barred from access, the UE 102 may proceed to operation 214. Otherwise, the UE 102 may proceed to operation 208 (to acquire a different cell 113). At operation 214, the UE 102 may acquire and decode SIB 1 (e.g., transmitted by the BS 112 at operation 212). The UE 102 may read SIB 1 and extract a PLMN ID from SIB 1. The PLMN ID may indicate a PLMN to which the cell 113 (served by the BS 112) belongs.

At operation 216, the UE 102 may determine whether the PLMN ID associated with the cell 113 matches a preferred network based on a list of PLMNs and associated RATs in a priority order stored at the UE 102. In an example, the list of PLMNs and associated RATs in the priority order may be configured by the home operator of the UE 102. In an example, the list of PLMNs and associated RATs in the priority order may be stored at a SIM card or eSIM of the UE 102. As discussed above, the list may include an HPLMN ID, VPLMN ID(s), EHPLMN ID(s), SNPN ID(s). In some instances, the UE 102 may also be configured with a list of FPLMN ID(s) that the UE 102 is not allowed to access. Thus, if the UE determines that the PLMN ID associated with the cell 113 matches one of the HPLMN ID, VPLMN ID(s), EHPLMN ID(s), or SNPN ID(s), the UE 102 may determine that that PLMN as a candidate PLMN. If, however, the PLMN ID matches an FHPLMN ID or does not match any of the HPLMN ID, VPLMN IDs, EHPLMN ID, or SNPN ID(s), the UE 102 may disregard that PLMN as a candidate PLMN.

As an example, the UE 102 may have acquired MIBs and SIBs1 from various other BSs112 (based on a matched secure token 105 in those MIBs) and collected PLMN IDs associated with those BSs 112 using similar mechanisms as in the operations 204 and 214 discussed above. Thus, as part of determining whether the PLMN ID associated with the cell 113 matches a preferred network, the UE 102 may determine whether PLMN ID obtained from the SIB 1 received at operation 212 has a higher priority than all the other collected PLMN IDs according to the list of PLMNs and associated RATs in the priority order. If the PLMN ID obtained from the SIB 1 received at operation 212 matches a preferred network (i.e., has a higher priority than all the collected PLMN ID), the UE 102 may proceed to operation 218. Otherwise, the UE 102 may proceed to operation 208 (e.g., to acquire a different cell 113).

At operation 218, the UE 102 may perform RSPP measurements to select a cell 113. For instance, the UE 102 may read the SIB 1 (acquired at operation 214) and extract minimum required reference signal received power (RSRP) thresholds (e.g., RxLevmin thresholds) from SIB 1. The UE 102 may measure RSRP of a cell 113 based on reference signals in SSBs. For instance, the UE 102 may perform RSRP measurements of different cells 113 within the PLMN selected at operation 218. The UE 102 may compare the RSRP measurements of the different cells 113 to select a cell 113 with the strongest signal strength (e.g., highest RSRP measurement). The UE 102 may perform the RSRP measurement comparison and the cell selection based on the RxLevmin thresholds (obtained from SIB 1). At operation 220, after selecting the cell 113 with the strongest signal strength, the UE 102 may camp on the selected cell 113. As part of camping on the selected cell 113, the UE 102 may perform a network attachment or registration procedure with a CN 120 coupled to the selected cell 113 (e.g., via NAS signaling).

In some embodiments, the UE 102 may bypass the verification of a secure token 105 in a MIB received at operation 204 based on a special call (e.g., an emergency call, such as a 911 number, a 112 number, or any other country-specific emergency number) being initiated at the UE. In this way, the special call may not be gated in case the secure token verification at operation 206 fails. In some embodiments, the UE 102 may receive update secure token(s) 105 from the home operator for communicating with the HPLMN and/or with VPLMNs.

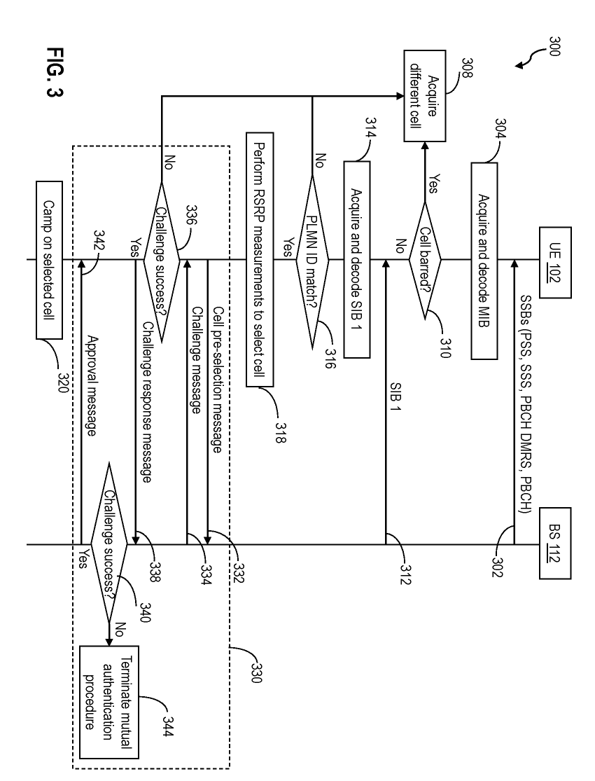

Turning now to FIG. 3, a method 300 of providing UE-BS mutual authentication-based security protection in a RAN 110 is described. The method 300 illustrates operations performed by various components of the wireless communication system 100. Specifically, the components include a UE 102 and a BS 112. In an embodiment, the operations of the UE 102 in method 300 may be implemented by a secure RAN access module 104 at the UE 102, and the operations of the BS 112 in the method 300 may be implemented by a secure RAN access module 114 at the BS 112. In some embodiments, each of UE 102 and the BS 112 may implement the operations of the method 300 using a computer system with components as shown in FIG. 8. As illustrated, FIG. 3 includes a number of enumerated operations, but embodiments of the operations in FIG. 3 may include additional operations before, after, and in between the enumerated operations. In some embodiments, one or more of the enumerated operations may be omitted or performed in a different order.

In the method 300, to facilitate UE-BS mutual authentication, an HLPMN (or a home operator) provisions all UEs 102 and all BSs 112 of the HPLMN with pre-shared secret information 107 that can be routinely changed (or updated). The HPLMN further provisions all UEs 102 and all BSs 112 with a variable 108 that may be updated more frequently than the pre-shared secret. The pre-shared secret information 107 and the variable 108 are stored at each respective BS 112 and UE 102. A BS 112 and a UE 102 perform a mutual authentication procedure based on the pre-shared secret information 107 and the variable 108. To facilitate roaming, the HPLMN further provisions each UE 102 with another pre-shared secret information 107 (e.g., roaming pre-shared secret information 107) and another variable 108 (e.g., a roaming variable 108) and provide roaming partner networks with the roaming pre-shared secret information 107 and the roaming variable 108. Thus, each roaming partner network configures BSs 112 of the roaming partner network with the roaming pre-shared secret information 107 and the roaming variable 108 to provide RAN security protection to roaming UEs 102. Further, the HPLMN may configure each BS 112 and each UE 102 (of the HPLMN) respectively with a pair of BS public and private keys 119 and a pair of UE public and private keys 109 for use in a UE-BS mutual authentication procedure. The HPLMN may also configure each UE 102 (of the HPLMN) with a pair of roaming UE public and private keys 109 for use in a UE-BS mutual authentication procedure during roaming and may provide roaming partner networks with a pair of roaming BS public and private keys 119 for use in a UE-BS mutual authentication procedure.

Generally speaking, the method 300 includes features similar to method 200 in many respects. For example, operations 302, 304, 308, 310, 312, 314, 316, 318, and 320 are similar to operations 202, 204, 208, 210, 212, 214, 216, 218, and 220, respectively. Accordingly, for brevity, details of those operations will not be repeated here. The method 300 differs from the method 200 in that a mutual authentication procedure 330 between a BS 112 and a UE 102 is used instead of a secure token 105 verification.

As shown in FIG. 3, the authentication procedure 330 is performed after the UE 102 selected a cell 113 (e.g., with the highest RSRP measurement) within a selected PLMN at operation 318 and before camping on the selected cell 113 at operation 320. For example, at operation 332, the UE 102 may initiate the authentication procedure 330 by transmitting, to the BS 112, a pre-selection message (e.g., indicating a request for authentication). At operation 334, upon the BS 112 receiving the pre-selection message, the BS 112 may transmit, to the UE 102, a challenge message (e.g., including a challenge value, which may be a numeric value, an alphanumeric string, a binary value, a hexadecimal value, etc.) associated with the authentication procedure 330. For instance, the BS 112 may generate the challenge value based on first pre-shared secret information 107 and a first variable 108 stored at the BS 112, where the first pre-shared secret information 107 is between the BS 112 and UEs 102 that are of the same operator as the BS 112. In some instances, the challenge message may include a hash of the first pre-shared secret information 107 and the first variable 108. The first pre-shared secret information 107 and the first variable 108 may be combined in any suitable way (e.g., adding, subtracting, any bitwise operations, etc.) to form an input to the hash function.

At operation 336, upon the UE 102 receiving the challenge message, the UE 102 may decode the challenge message to verify an identity of the BS 112 (e.g., the first pre-shared secret information 107 embedded in the challenge message). The verification may include determining whether the decoded first pre-shared secret information 107 matches second pre-shared secret information 107 stored at the UE 102, where the second pre-shared secret information 107 is shared between the UE 102 and BSs 112 associated with the home operator of the UE 102 or associated with a roaming operator (e.g., a roaming partner of the home operator).

If the verification of the BS identity fails (e.g., a mismatch between the decoded first pre-shared secret information 107 matches second pre-shared secret information 107 stored at the UE 102), the UE 102 may proceed to operation 308. At operation 308, the UE 102 may acquire a different cell 113 as discussed above at operation 208 of the method 200. In some instances, the UE 102 may select a next strongest cell 113 in the selected PLMN (e.g., based on the RSRP measurements collected at operation 318) and perform an authentication procedure 330 with a BS 112 of that next strongest cell 113 (e.g., using similar mechanisms as in authentication procedure 330). If, however, the verification is successful, the UE 102 may proceed to operation 338. At operation 338, the UE 102 may transmit a challenge response message (e.g., including a response value, which may be a numeric value, an alphanumeric string, a binary value, a hexadecimal value, etc.) in response to the challenge message from the BS 112. For instance, the UE 102 may generate the response value based on the second pre-shared secret information 107 and a second variable 108 stored at the UE 102. In some instances, the challenge response message may include a hash of the second pre-shared secret information 107 and the second variable 108. The second pre-shared secret information 107 and the second variable 108 may be combined in any suitable way (e.g., adding, subtracting, any bitwise operations, etc.) to form an input to the hash function.

At operation 340, upon the BS 112 receiving the challenge response message, the BS 112 may decode the challenge response message to verify an identity of the UE 102 (e.g., the second pre-shared secret information 107 embedded in the challenge response message). The verification may include determining whether the decoded second pre-shared secret information 107 matches the first pre-shared secret information 107 stored at the BS 112. Generally, the BS 112 and the UE 102 may each utilize respective pre-shared secret information 107 and variable 108 from the pre-shared secret information 107 and variable 108 configured for HPLMN use or the roaming pre-shared secret information 107 and variable 108 configured for roaming at operations 334, 336, 338, and 340 based on whether the UE 102 is in an HPLMN or not.

If the verification of the identify of the UE 102 is unsuccessful (a mismatch between the decoded second pre-shared secret information 107 and the first pre-shared secret information 107 stored at the BS 112), the BS 112 may proceed to operation 344. At operation 344, the BS 112 may terminate the authentication procedure 330 and may not allocate further resources for communications with the UE 102. If, however, the verification is successful, the BS 112 may proceed to operation 342. At operation 342, the BS 112 may transmit, to the UE 102, an approval message to approve the UE 102 to continue with the cell selection. At operation 320, upon the UE 102 receiving the approval message, the UE 102 may proceed to camp on the cell 113 as discussed above at operation 220 of the method 200. If, however, the UE 102 fails to receive the approval message from the BS 112 after transmitting the challenge response message at operation 338 and/or a certain time has elapsed, the UE 102 may select a next strongest cell 113 within the selected PLMN (e.g., based on the RSRP measurements collected at operation 318) and perform an authentication procedure 330 with a BS 112 of that next strongest cell 113 (e.g., using similar mechanisms as in the authentication procedure 330).

In some embodiments, the challenge message transmitted by the BS 112 at operation 334 and the challenge response message transmitted by the UE 102 at operation 338 are encrypted. For instance, the BS 112 and the UE 102 may each select a respective key-pair from a pair of public and private keys 119 and 109 for HPLMN use or from a pair of roaming public and private keys 119 and 109 for roaming based on whether the UE 102 is in an HPLMN or not. The BS 112 may further encrypt the challenge message (transmitted at operation 334) using a respective BS public key 119, and the UE 102 may decrypt the challenge message (at operation 336) using a respective UE private key 109. Similarly, the UE 102 may further encrypt the challenge response message (transmitted at operation 338) using a respective UE public key 109, and the BS 112 may decrypt the challenge response message (at operation 340) using a respective BS private key 119.

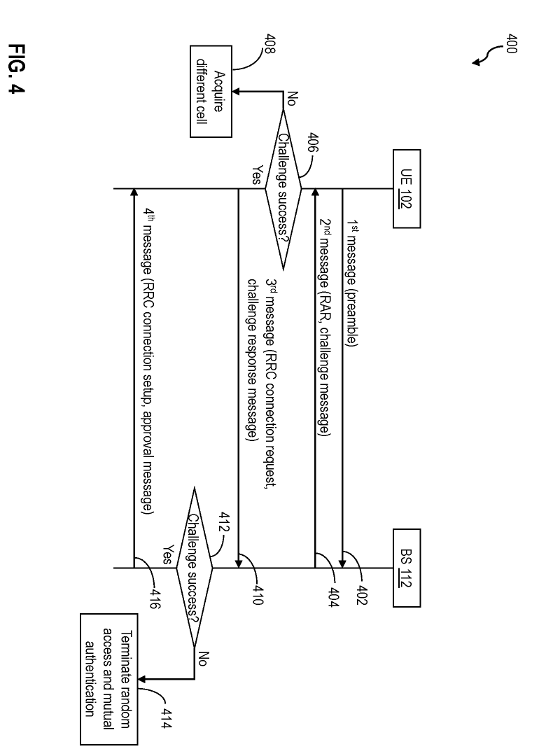

In some embodiments, the UE 102 may bypass the authentication procedure 330 (e.g., the operations 332-344) based on a special call (e.g., an emergency call, such as a 911 number, a 112 number, or any other country-specific emergency number) being initiated at the UE. In this way, the special call may not be gated in case the authentication procedure 330 with the BS 112 fails. In some embodiments, the UE 102 and/or the BS 112 may receive updated pre-shared secret information 107, updated variable 108s, and/or updated public-private key pairs (e.g., the UE keys 109 and/or the BS keys 119) for the authentication procedure 330 in an HPLMN or a roaming network. In some embodiments, the authentication procedure 330 may be incorporated into a random access procedure as will be discussed more fully below with reference to FIG. 4. In other embodiments, the UE 102 may perform a random access procedure with the BS 112 before performing the authentication procedure 330. In some embodiments, the UE 102 and the BS 112 may utilize a combination of secure token verification (e.g., at operation 206) and the authentication procedure 330 discussed above with reference to FIGS. 2 and 3, respectively, during cell selection and/or cell reselection.

Turning now to FIG. 4, a method 400 of performing a mutual authentication procedure 330 between a UE 102 and a BS 112 as part of a random access procedure is described. The method 400 illustrates operations performed by various components of the wireless communication system 100. Specifically, the components include a UE 102 and a BS 112. In an embodiment, the operations of the UE 102 in method 400 may be implemented by a secure RAN access module 104 at the UE 102, and the operations of the BS 112 in the method 400 may be implemented by a secure RAN access module 114 at the BS 112. In some embodiments, each of UE 102 and the BS 112 may implement the operations of the method 400 using a computer system with components as shown in FIG. 8. As illustrated, FIG. 4 includes a number of enumerated operations, but embodiments of the operations in FIG. 4 may include additional operations before, after, and in between the enumerated operations. In some embodiments, one or more of the enumerated operations may be omitted or performed in a different order.

The method 400 illustrates a contention-based random access procedure integrated with authentication procedure 330. At operation 402, the UE 102 transmit a first message (e.g., MSG 1) including a preamble (e.g., a waveform sequence) through a PRACH to initiate communication with the BS 112. Generally, the BS 112 may provide a set of available preambles (e.g., preamble indices) and a PRACH configuration through system information (e.g., SIB 1). The UE 102 may randomly select a preamble index from the set of preamble indices. The UE 102 may transmit the preamble on time-frequency resources indicated by the PRACH configuration. The preamble may operate as the pre-selection message that initiates the authentication procedure 330.

At operation 404, upon the BS 112 receiving the preamble (the first message), the BS may transmit, to the UE 102, a second message (e.g., MSG 2) including a random access response (RAR) to the received preamble. The RAR may include index information of the preamble used at operation 402, uplink transmission timing correction information, uplink resource allocation information to be used in a subsequent transmission by the UE 102 (e.g., at operation 410), and temporary identifier information for the UE 102 (e.g., a random access-radio network temporary identifier (RA-RNTI)). Additionally, the BS 112 may include, in the second message, a challenge message for the UE 102 as part of the authentication procedure 330. The BS 112 may generate the challenge message as discussed above at operation 334 of the method 300.

At operation 406, upon the UE 102 receiving the challenge message (in the second message), the UE 102 may decode the challenge to verify an identity of the BS 112 as discussed above with reference to operation 336 of the method 300. If the verification of the identity of the BS 112 fails, the UE 102 may proceed to operation 408. At operation 408, the UE 102 may acquire a different cell 113 as discussed above at operation 208 of the method 200. If, however, the verification is successful, the UE 102 may proceed to operation 410. Generally, the UE 102 may determine that the second message is intended for the UE 102 based on the index information (in the RAR) matching the random preamble index of the preamble transmitted at operation 402.

At operation 410, the UE 102 may transmit, to the BS 112, a third message (e.g., MSG 3) including an RRC connection request and a challenge response message. The RRC connection request is a request to establish an RRC connection (e.g., an initial connection) with the BS 112. The UE 102 may generate the challenge response message as discussed above with reference to operation 338 of the method 300. The UE 102 may monitor a physical downlink control channel (PDCCH) for an uplink scheduling grant based on the RA-RNTI (indicated in the RAR). Upon detecting an uplink scheduling grant in the PDCCH, the UE 102 may transmit the third message (including the RRC connection request and the challenge response message) using a resource (e.g., time-frequency resource in a physical uplink shared channel (PUSCH)) indicated by the uplink scheduling grant.

At operation 412, upon the BS 112 receiving the third message including the challenge response message, the BS 112 may decode the challenge response message to verify an identity of the UE 102. If the verification of the identity of the UE 102 is unsuccessful, the BS 112 may proceed to operation 414. At operation 414, the BS 112 may terminate the random access procedure and the authentication procedure 330 and may not allocate further resources for communications with the UE 102. If, however, the verification at operation 412 is successful, the BS 112 may proceed to operation 416. At operation 416, the BS 112 may transmit, to the UE 102, a fourth message (e.g., MSG 4, which is a contention resolution) including an indication of an RRC connection setup and an approval (e.g., for the UE 102 to continue to access the cell 113).

As can be seen in FIG. 4, the pre-selection message, the challenge message, the challenge response message, and the approval message in the authentication procedure 330 may be part of MSG 1, MSG 2, MSG 3, and MSG 4 of a contention-based random access procedure (e.g., as defined by 3GPP), respectively. For a contention free random access procedure, the pre-selection message may correspond to a PRACH preamble, the challenge message (transmitted by the BS) may be part of a RAR. The exchange of the challenge response message and the approval message may be additional to the contention free random access procedure. Further, for a 2-step random access procedure including message A (MSG A) and message B (MSG B), the pre-selection message may be part of MSG A, and the challenge message (transmitted by the BS) may be part of MSG B. The exchange of the challenge response message and the approval message may be additional to the 2-step random access procedure. In other embodiments, the UE 102 may perform a random access procedure (e.g., a contention-based random access or contention free random access) before performing the authentication procedure 330.

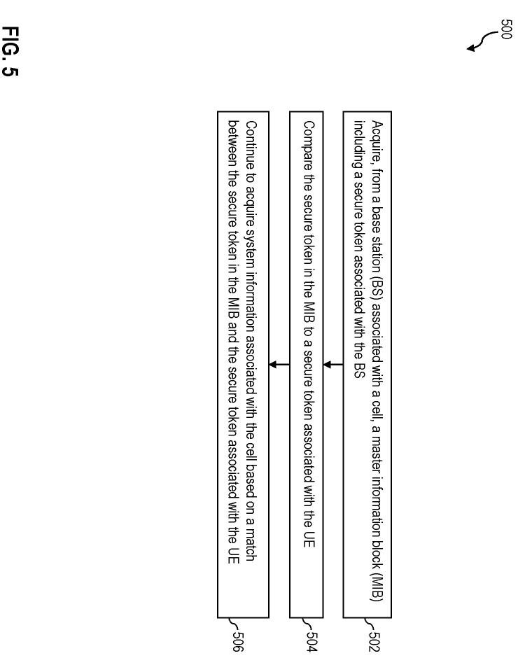

Turning now to FIG. 5, a method 500 is described. In an embodiment, the method 500 is a method of performing secure token-based RAN access. The method 500 may be implemented by a UE 102 (e.g., a secure RAN access module 104 at the UE 102). The method 500 may include similar mechanisms as discussed above with reference to FIGS. 1A-1B and 2. In some embodiments, the method 500 may be implemented using a computer system with components as shown in FIG. 8. As illustrated, FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At block 502, a UE 102 acquires, from a BS 112 associated with a cell 113, a MIB including a secure token 105 associated with the BS 112. In an embodiment, the secure token 105 associated with the BS 112 is further associated with an operator of the BS 112. The secure token 105 associated with the BS 112 is further associated with an operator of the BS 112.

At block 504, the UE 102 compares the secure token 105 in the MIB to a secure token 105 associated with the UE 102 (e.g., to verify the authenticity of the BS 112). In an embodiment, the secure token 105 associated with the UE 102 is a preconfigured secure token 105 stored at the UE 102 (e.g., at a SIM card or eSIM of the UE 102). In an embodiment, the secure token 105 associated with the UE 102 is further associated with a home operator of the UE 102. For instance, the UE 102 may be configured (e.g., by the home operator) with a specific secure home token for verifying the authenticity of a BS 112 in a home operator network (e.g., HPLMN). In another embodiment, the secure token 105 associated with the UE 102 is further associated with a roaming operator of the UE 102. For instance, the UE 102 may be configured (e.g., by the home operator) with a specific secure home token for verifying the authenticity of a BS 112 in a roaming network (e.g., VLPMN) when the UE 102 is outside the coverage of the home operator network. In an embodiment, the secure token 105 is received in a secure token update indication. That is, the secure token 105 at the UE 102 can be dynamically updated (e.g., by the home operator of the UE 102).

At block 506, the UE 102 continues to acquire system information associated with the cell 113 based on a match between the secure token 105 in the MIB and the secure token 105 associated with the UE 102. As part of continuing to acquire the system information associated with the cell 113, the UE 102 acquires, from the BS 112, a SIB 1.

In some embodiments, the UE 102 further acquires, from a second BS 112 associated with a second cell 113, a second MIB including a second secure token 105 associated with the second BS 112. The UE 102 further compares the second secure token 105 in the second MIB to the secure token 105 associated with the UE 102 (e.g., to verify the authenticity of the second BS 112). The UE 102 further acquires a different cell 113 than the second cell 113 based on a mismatch between the second secure token 105 in the second MIB and the secure token 105 associated with the UE 102.

In some embodiments, the UE 102 further acquires, from a second BS 112 a second MIB including a second secure token 105 associated with the second BS 112. The UE 102 further bypasses a verification of the second secure token 105 in the second MIB based on an initiation of a special call (e.g., an emergency call, such as a 911 number, a 112 number, or any other country-specific emergency number) at the UE 102.

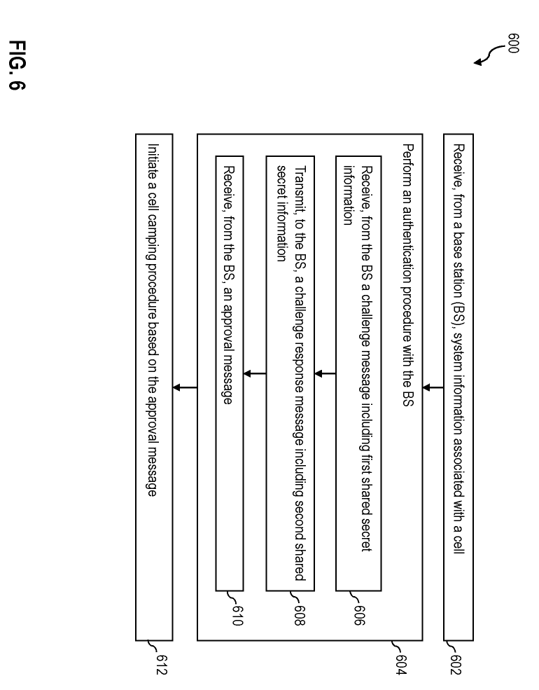

Turning now to FIG. 6, a method 600 is described. In an embodiment, the method 600 is a method of performing secure RAN access based on a secure token 105 verification and/or a mutual authentication procedure 330 between a BS 112 and a UE 102. The method 600 may be implemented by a UE 102 (e.g., a secure RAN access module 104 at the UE 102). The method 600 may include similar mechanisms as discussed above with reference to FIGS. 1A-1B and 2-5. In some embodiments, the method 600 may be implemented using a computer system with components as shown in FIG. 8. As illustrated, FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At block 602, a UE 102 receives, from a BS 112, system information associated with a cell 113. At block 604, the UE 102 performs an authentication procedure 330 with the BS 112. As part of performing the authentication procedure, the UE 102 performs operations at blocks 606-610. At block 606, the UE 102 receives, from the BS 112, a challenge message including first shared secret information 107. In an embodiment, the challenge message further includes a first variable 108. In an embodiment, the first shared secret information 107 and the first variable 108 are stored at the BS 112. In an embodiment, the first shared secret information 107 and the first variable 108 are shared between the BS 112 and a second UE 102 that is associated with an operator of the BS 112. In an embodiment, the challenge message further includes a hash of the first shared secret information 107 and the first variable 108.

At block 608, the UE 102 transmits, to the BS 112, a challenge response message including second shared secret information 107. In an embodiment, the challenge response message further includes a second variable 108. In an embodiment, the second shared secret information 107 and the second variable 108 are stored at the UE 102. In an embodiment, the second shared secret information 107 is between the UE 102 and a second BS 112 that is associated with a home operator of the UE 102 or a roaming operator of the UE 102. In an embodiment, the challenge response message further includes a hash of the second shared secret information 107 and the second variable 108. At block 610, the UE 102 receives, from the BS 112, an approval message (e.g., indicating an approval to continue with selecting the cell 113). At block 612, the UE 102 initiates a cell selection procedure based on the approval message.

In an embodiment, as part of performing the authentication procedure at block 604, the UE 102 further transmits, to the BS 112, a cell pre-selection message to preselect the cell 113, where the challenge message received at block 606 is based on (in response to) the cell pre-selection message. Further, the UE 102 decodes the challenge message to verify an identity (e.g., the first shared secret information) of the BS 112. For instance, the UE 102 may obtain the first shared secret information from the decoding and compare the first shared secret information 107 to the second shared secret information stored at the UE 102. The challenge response message transmitted at block 608 is based on a match between the first shared secret information 107 (in the challenge message) and the second shared secret information stored at the UE 102 (e.g., as discussed above with reference to FIG. 3). In an embodiment, the authentication procedure is incorporated into a random access procedure. In such an embodiment, the pre-selection message includes a PRACH preamble, and the challenge message received at block 606 further includes a RAR (e.g., as discussed above with reference to FIG. 4).

In an embodiment, as part of the receiving the system information associated with the cell 113 at block 602, the UE 102 receives, from the BS 112, a MIB including a secure token 105 associated with the BS 112, and the performing the authentication procedure at block 604 is based on a match between the secure token 105 associated with the BS 112 and a secure token 105 stored at the UE 102 (e.g., as discussed above with reference to FIGS. 2 and 5). In an embodiment, the UE 102 further acquires, from a second BS 112, second system information and bypasses an authentication procedure 330 between the second BS 112 and the UE 102 based on an initiation of a special call (e.g., an emergency call, such as a 911 number, a 112 number, or any other country-specific emergency number) at the UE 102.

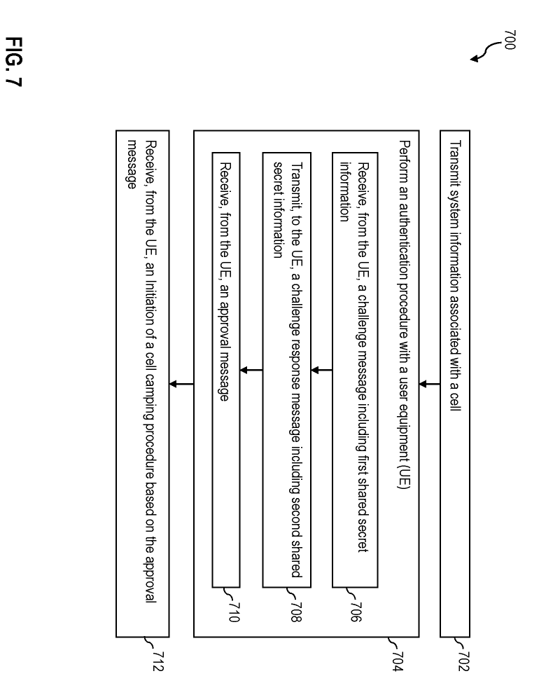

Turning now to FIG. 7, a method 700 is described. In an embodiment, the method 600 is a method of providing secure RAN access through an inclusion of a secure BS 112 in a MIB and/or a mutual authentication procedure 330 between a BS 112 and a UE 102. The method 700 may be implemented by a BS 112 (e.g., a secure RAN access module 114 at the BS 112). The method 700 may include similar mechanisms as discussed above with reference to FIGS. 1A-1B and 2-6. In some embodiments, the method 700 may be implemented using a computer system with components as shown in FIG. 8. As illustrated, FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At block 702, a BS 112 transmits, to a UE 102, system information associated with a cell 113. At block 704, the BS 112 performs an authentication procedure 330 with the UE 102. As part of performing the authentication procedure, the BS 112 performs operations at blocks 706-710. At block 706, the BS 112 transmits, to the UE 102, a challenge message including first shared secret information 107. In an embodiment, the challenge message further includes a first variable 108. In an embodiment, the first shared secret information 107 and the first variable 108 are stored at the BS 112. In an embodiment, the first shared secret information 107 and the second variable 108 are shared between the BS 112 and a second UE 102 that is associated with an operator of the BS 112. In an embodiment, the challenge message further includes a hash of the first shared secret information 107 and the first variable 108.

At block 708, the BS 112 receives, from the UE 102, a challenge response message including second shared secret information 107. In an embodiment, the challenge response message further includes a second variable 108. In an embodiment, the second shared secret information 107 and the second variable 108 are stored at the UE 102. In an embodiment, the second shared secret information 107 is between the UE 102 and a second BS 112 that is associated with a home operator of the UE 102 or a roaming operator of the UE 102. In an embodiment, the challenge response message further includes a hash of the second shared secret information 107 and the second variable 108. At block 710, the BS 112 transmits, to the UE 102, an approval message (e.g., indicating an approval to continue with selecting the cell 113). At block 712, the BS 112 receives, from the UE 102, an initiation of cell selection procedure based on the approval message.

In an embodiment, as part of performing the authentication procedure at block 704, the BS 112 further receives, from the UE 102, a cell pre-selection message to preselect the cell 113, where the challenge message received at block 706 is based on (in response to) the cell pre-selection message. Further, the BS 112 decodes the challenge response message to verify an identity (e.g., the second shared secret information) of the UE 102. For instance, the BS 112 may obtain the second shared secret information from the decoding and compare the second shared secret information 107 to the first shared secret information stored at the BS 112. The approval message transmitted at block 710 is based on a match between the second shared secret information 107 (in the challenge response message) and the first shared secret information stored at the BS 112 (e.g., as discussed above with reference to FIG. 3). In an embodiment, the authentication procedure is incorporated into a random access procedure. In such an embodiment, the pre-selection message includes a PRACH preamble, and the challenge message transmitted at block 706 further includes a RAR (e.g., as discussed above with reference to FIG. 4).

In an embodiment, as part of the transmitting the system information associated with the cell 113 at block 702, the BS 112 transmits a MIB including a secure token 105 associated with the BS 112. In an embodiment, the BS 112 further receives, from a second UE 102, a message including an indication of a special call (e.g., an emergency call, such as a 911 number, a 112 number, or any other country-specific emergency number), and the BS 112 further bypasses an authentication procedure 330 between the BS 112 and the second UE 102 based on an initiation of the special call.

In a further embodiment, to prevent UEs 102 from camping on a false BS 112, a secure token 105 is stored in the gNB (e.g., BS 112) and is broadcasted in the MIB. The HPLMN also provisions each UE with the same secure token 105. When the UE 102 receives the MIB and decodes the token, it compares it. If the two are the same, the UE 102 assumes this is a legit gNB/base station. If it is different, the UE assumes it is a FBS and does not proceed to attach. Preconditions include 1) gNB (e.g., BS 112) and UEs 102 are preconfigured with an updatable/dynamic secure token 105 by the HPLMN, and 2) for roaming, the preferred roaming partner networks’ secure token 105 will be provided to the UE 102 by the HPLMN. Modified cell selection procedure includes UE 102 acquires/decodes the MIB. UE 102 acquires/decodes the gNB’s secure token 105 and compares it to their stored secure token 105. If they match, the process continues. If there is a mismatch (assumes a false BS), the UE 102 will acquire a different cell 113.

In a further embodiment, a UE-gNB mutual authentication procedure (e.g., a UE-BS mutual authentication 330) is incorporated into the cell selection procedure. Precondition(s) include the HPLMN provisioning all UEs 102 and gNBs (e.g., BSs 112) with a pre-shared secret (e.g., pre-shared secret information 107). These are longer-term variables that can be routinely changed/updated and are stored in the tamper-proof module. Precondition(s) further includes the HPLMN provisioning all UEs 102 and gNBs with a temporary variable 108 that is more frequently changed/updated that is used to create the dynamic hashed value. Modified cell selection procedure includes mutual authentication steps after UE selected the strongest cell 113 within selected PLMN. The mutual authentication steps include the following:

The UE 102 sends a (new) pre-selection message to the gNB.

The gNB responds with a challenge which is a message that includes a hash of the pre-shared secret and a variable 108.

The UE 102 receives the challenge and decodes to verify the gNB’s identity (pre-shared secret) and responds to the challenge by sending its challenge to the gNB. The UE 102’s challenge is a hash of the pre-shared key and a variable 108.

The gNB receives the challenge and decodes to verify the UE 102’s identity. The gNB then sends a message to the UE 102 that approves the UE 102 to continue with the cell selection.

FIG. 8 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), IP, time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method performed by a user equipment (UE) in a wireless communication system, the method comprising:
receiving, from a base station (BS), system information associated with a cell; and
performing an authentication procedure with the BS, wherein the performing the authentication procedure comprises:
receiving, from the BS, a challenge message comprising first shared secret information or a first variable;
transmitting, to the BS, a challenge response message comprising second shared secret information; and
receiving, from the BS, an approval message; and
initiating a cell camping procedure based on the authentication procedure.

2. The method of claim 1, wherein:
the challenge message comprises a hash of the first shared secret information and a first variable, and
the challenge response message comprises a hash of the second shared secret information and a second variable.

3. The method of claim 2, wherein:
the first shared secret information is between the BS and a second UE that is associated with an operator of the BS, and
the second shared secret information is between the UE and a second BS that is associated with a home operator of the UE or a roaming operator of the UE.

4. The method of claim 1, wherein the performing the authentication procedure further comprises:
transmitting, to the BS, a cell pre-selection message to preselect the cell, wherein the challenge message is received based on the cell pre-selection message; and
decoding the challenge message to verify an identity of the BS.

5. The method of claim 4, wherein:
the transmitting the cell pre-selection message comprises:
transmitting a physical random access channel (PRACH) preamble, and
the receiving the challenge message comprises:
receiving a message including a random access response (RAR) and the challenge message.

6. The method of claim 1, further comprising:
acquiring, from a second BS, second system information; and
bypassing an authentication between the second BS and the UE based on an initiation of a special call at the UE.

7. The method of claim 1, wherein:
the receiving the system information associated with the cell comprises:
receiving, from the BS, a master information block (MIB) comprising a secure token associated with the BS, and
the performing the authentication procedure with the BS is based on a match between the secure token in the MIB and a secure token stored at the UE.

8. A method performed by a base station (BS) serving a cell in a wireless communication system, the method comprising:
transmitting system information associated with the cell; and
performing an authentication procedure with a user equipment (UE), wherein the performing the authentication procedure comprises:
transmitting, to the UE, a challenge message comprising first pre-shared secret information;
receiving, from the UE, a challenge response message comprising second pre-shared secret information; and
transmitting, to the UE, an approval message;
receiving, from the UE, an initiation of a camping procedure based on the authentication procedure.

9. The method of claim 8, wherein:
the challenge message comprises a hash of the first shared secret information and a first variable, and
the challenge response message comprises a hash of the second shared secret information and a second variable.

10. The method of claim 8, wherein:
the first shared secret information is between the BS and a second UE that is associated with an operator of the BS, and
the second shared secret information is between the UE and a second BS that is associated with a home operator of the UE or a roaming operator of the UE.

11. The method of claim 8, wherein the performing the authentication procedure further comprises:
receiving, from the UE, a cell pre-selection message to preselect the cell, wherein the challenge message is transmitted based on the cell pre-selection message; and
decoding the challenge response message to verify an identity of the UE.

12. The method of claim 11, wherein:
the receiving the cell pre-selection message comprises:
receiving, from the UE, a physical random access channel (PRACH) preamble, and
the transmitting the challenge message comprises:
transmitting, to the UE, a message further comprising a random access response (RAR) and the challenge message.

13. The method of claim 8, further comprising:
receiving, from a second UE, a message comprising an indication of a special call; and
bypassing an authentication between the BS and the second UE based on the indication of the special call.

14. The method of claim 8, wherein the transmitting the system information associated with the cell comprises:
transmitting a master information block (MIB) comprising a secure token associated with the BS.

15. A method performed by a user equipment (UE) in a wireless communication system, the method comprising:
acquiring, from a base station (BS) associated with a cell, a master information block (MIB) comprising a secure token;
comparing the secure token in the MIB to a secure token associated with the UE; and
continuing to acquire system information associated with the cell based on a match between the secure token in the MIB and the secure token associated with the UE.

16. The method of claim 15, further comprising:
acquiring, from a second BS associated with a second cell, a second MIB comprising a second secure token; and
comparing the second secure token in the second MIB to the secure token associated with the UE; and
acquiring a different cell than the second cell based on a mismatch between the second secure token in the second MIB and the secure token associated with the UE.

17. The method of claim 15, wherein the secure token associated with the UE is a preconfigured secure token stored at the UE.

18. The method of claim 15, further comprising:
receiving a secure token update indication comprising the secure token.

19. The method of claim 15, wherein the secure token associated with the UE is further associated with a home operator of the UE or a roaming operator of the UE.

20. The method of claim 15, further comprising:
acquiring, from a second BS a second MIB comprising a second secure token; and
bypassing a verification of the second secure token in the second MIB based on an initiation of a special call.
